(19) United States
(12) Patent Application Publication
(10) Pub. No.: US 2026/0105927 A1
(43) Pub. Date: Apr. 16, 2026

(54) METHOD, APPARATUS AND ELECTRONIC DEVICE FOR PROCESSING AUDIO

(71) Applicant: DOUYIN VISION CO., LTD., Shijingshan District, Beijing (CN)

(72) Inventors: Shilei Liu, Beijing (CN); Xuzhou Ye, Beijing (CN); Qiuqiang Kong, Beijing (CN); Chuanzeng Huang, Beijing (CN); Junjie Shi, Beijing (CN); Derong Liu, Beijing (CN); Zhengpu Zhang, Beijing (CN)

(21) Appl. No.: 19/113,752

(22) PCT Filed: Nov. 8, 2023
(86) PCT No.: PCT/CN2023/130563

§ 371 Date: Mar. 20, 2025

(30) Foreign Application Priority Data
Nov. 15, 2022 (CN) 202211430307.6

(51) Int. Cl. G10L 19/26; G10L 19/02

(52) U.S. Cl. CPC G10L 19/26; G10L 19/02

(57) ABSTRACT

The disclosure provides a method, an apparatus and an electronic device for processing an audio. The method includes: obtaining a first audio and a target frequency response curve; adjusting a plurality of filter parameters of a first group of filters in an electronic device based on the target frequency response curve to obtain a target group of filters, a similarity between a frequency response curve associated with the target group of filters and the target frequency response curve being greater than a predetermined threshold; processing the first audio based on the target group of filters to obtain a second audio. The audio processing efficiency is improved.

This application claims the priority to Chinese Patent Application No. 202211430307.6, filed on Nov. 15, 2022, and entitled “METHOD, APPARATUS AND ELECTRONIC DEVICE FOR PROCESSING AUDIO”, the entirety of which is incorporated herein by reference.

### FIELD

The embodiments of the disclosure relate to the field of audio processing technologies, and in particular, to a method, an apparatus, and an electronic device for processing an audio.

### BACKGROUND

In optimizing the sound effect of the audio, the frequency response of the audio may be adjusted through a filter to change the style of the music, thus more balanced listening characteristics are obtained.

At present, the parameters of the filter may be adjusted manually, so that the frequency response characteristic corresponding to the filter is the frequency response characteristic required for the audio adjustment, and then the audio is processed through the filter with adjusted parameters. However, manually adjusting the parameters of the filter is relatively complex, requiring rich experience in the adjustment, and takes a long time, leading to lower efficiency in audio processing.

### SUMMARY

The disclosure provides a method, an apparatus and an electronic device for processing an audio, for solving the technical problem of low efficiency of audio processing in the prior art.

In a first aspect, the disclosure provides a method for processing an audio. The method for processing an audio comprises:
obtaining a first audio and a target frequency response curve;
adjusting a plurality of filter parameters of a first group of filters in an electronic device based on the target frequency response curve to obtain a target group of filters, a similarity between a frequency response curve associated with the target group of filters and the target frequency response curve being greater than a predetermined threshold;
processing the first audio based on the target group of filters to obtain a second audio.

In a second aspect, the disclosure provides an apparatus for processing an audio, the apparatus comprises an obtaining module, an adjustment module and a processing module, wherein:
the obtaining module configured to obtain a first audio and a target frequency response curve, the first audio having a frequency response curve different from the target frequency response curve;
the adjusting module configured to adjust a plurality of filter parameters of a first group of filters in an electronic device based on the target frequency response curve to obtain a target group of filters, a similarity between a frequency response curve associated with the target group of filters and the target frequency response curve being greater than a predetermined threshold;
the processing module configured to process the first audio based on the target group of filters to obtain a second audio.

In a third aspect, the embodiment of the disclosure provides an electronic device, comprising: a processor and a memory;
the memory storing computer executable instructions; and
the processor executing the computer executable instruction stored in the memory, to cause the processor to execute a method for processing an audio according to the above aspect and various possible designs thereof.

In the fourth aspect, the embodiment of the disclosure provides a computer-readable storage medium. The computer-readable storage medium stores computer-executable instructions which, when executed by a processor, implement a method for processing an audio according to the above aspect and various possible designs thereof.

In a fifth aspect, the embodiment of the disclosure provides a computer program product, comprising a computer program, the computer program, when executed by a processor, implements a method for processing an audio according to the above aspect and various possible designs thereof.

The disclosure provides a method, an apparatus and an electronic device for processing an audio. The terminal device obtains a first audio and a target frequency response curve, wherein the frequency response curve of the first audio is different from the target frequency response curve. A plurality of filter parameters of a first group of filters in an electronic device is adjusted based on the target frequency response curve to obtain a target group of filters, wherein the similarity between a frequency response curve associated with the target group of filters and the target frequency response curve is greater than a predetermined threshold. The first audio is processed based on the target group of filters to obtain a second audio. In this method, since the electronic device may automatically adjust the plurality of filter parameters in the first group of filters based on the target frequency response curve, the electronic device may quickly obtain the target group of filters without manually adjusting the parameters of the filter. In such a way, the parameter adjustment complexity of the filter is reduced, and the efficiency of audio processing is improved.

### BRIEF DESCRIPTION OF DRAWINGS

In order to more clearly illustrate the embodiments of the disclosure or the technical solutions in the prior art, the accompanying drawings used in the description of the embodiments or the prior art will be briefly introduced below. It will be apparent that the drawings in the following description are some embodiments of the disclosure, and those skilled in the art may also obtain other drawings according to these drawings without creative labor.

FIG. 1 is a schematic diagram of an application scenario according to an embodiment of the disclosure;

FIG. 2 is a schematic flowchart of a method for processing an audio according to an embodiment of the disclosure;

FIG. 3 is a schematic diagram of obtaining a target frequency response curve according to an embodiment of the disclosure;

FIG. 4 is a schematic diagram of peak information according to an embodiment of the disclosure;

FIG. 5 is a schematic diagram of a method for determining a target group of filters according to an embodiment of the disclosure;

FIG. 6 is a schematic diagram of a first error according to an embodiment of the disclosure;

FIG. 7 is a schematic diagram of adjusting filter parameters according to an embodiment of the disclosure;

FIG. 8 is a schematic diagram of a process of a method for processing an audio according to an embodiment of the disclosure;

FIG. 9 is a schematic structural diagram of an apparatus for processing an audio according to an embodiment of the disclosure; and

FIG. 10 is a schematic structural diagram of an electronic device according to an embodiment of the disclosure.

### DETAILED DESCRIPTION

The example embodiments will be described in detail herein, examples of which are illustrated in the accompanying drawings. When referring to the accompanying drawings, unless otherwise indicated, the same numbers in different drawings represent the same or similar elements. The implementations described in the following embodiments do not represent all implementations consistent with the present disclosure. On the contrary, they are only examples of apparatuses and methods consistent with some aspects of the present disclosure as described in the accompanying claims.

For ease of understanding, the concepts involved in the embodiments of the disclosure are described below.

An electronic device is a device having a wireless transceiver function. The electronic device may be deployed on land, including indoor or outdoor, handheld, wearable, or on-board; or may be deployed on the water surface (for example, a ship, etc.). The electronic device may be a mobile phone, a Pad, a computer with a wireless transceiver function, a virtual reality (VR) electronic device, an augmented reality (AR) electronic device, a wireless terminal in industrial control, a on-board electronic device, a wireless terminal in a self-driving, a wireless electronic device in a remote medical device, a wireless electronic device in a smart grid, a wireless electronic device in transportation safety, a wireless electronic device in a smart city, a wireless electronic device in a smart home, a wearable electronic device, and the like. The electronic device according to the embodiments of the disclosure may also be referred to as a terminal, user equipment (UE), an access electronic device, an on-board terminal, an industrial control terminal, a UE unit, a UE station, a mobile station, a mobile station, a remote station, a remote electronic device, a mobile device, a UE electronic device, a wireless communication device, a UE agent, or a UE device. The electronic device may be stationary or mobile.

In the related art, the parameters of the filter may be adjusted manually. Thus, the frequency response characteristic corresponding to the filter is the frequency response characteristic required for the audio adjustment, and then the audio is processed through the filter with adjusted parameters. For example, if the terminal device starts the audio-video mode, the sound effect of the audio played by the terminal device is the audio-video effect. Therefore, the frequency response characteristic of the filter is the frequency response characteristic corresponding to the audio-video effect. The parameters of the group of filters are adjusted manually, so that the frequency response characteristic output by the group of filters is the frequency response characteristic corresponding to the audio-video effect, and then the audio played by the electronic device is processed through the group of filters. However, the manual adjustment for parameters of the filter is relatively complex, requiring rich experience of filter parameter adjustment, and the manual adjustment for parameter is time-consuming, leading the poor time efficiency and low processing efficiency of audio processing.

In order to solve the technical problem in the related art, an embodiment of the disclosure provides a method for processing an audio. The electronic device obtains a first audio and a target frequency response curve, and obtains peak information of the target frequency response curve, wherein the peak information is information of a wave peak or a wave trough in the target frequency response curve, and the peak value information comprises at least one of: a height, a width and a spectral position of a wave peak or a wave trough. The electronic device adjusts the plurality of filter parameters of the first group of filters based on the peak information and the target frequency response curve to obtain the target group of filters. Further, the electronic device processes the first audio based on the target group of filters to obtain the second audio. In the foregoing method, since the similarity between the frequency response curve corresponding to the target group of filters and the target frequency response curve is relatively high, the sound effect of the second audio obtained by the target group of filters is better, the audio processing effect is improved. In addition, since the electronic device may automatically adjust the plurality of filter parameters in the first group of filters based on the target frequency response curve, the electronic device may quickly obtain the target group of filters without manually adjusting the parameters of the filter, which reduce the parameter adjustment complexity of the filter, and further improve the efficiency of audio processing.

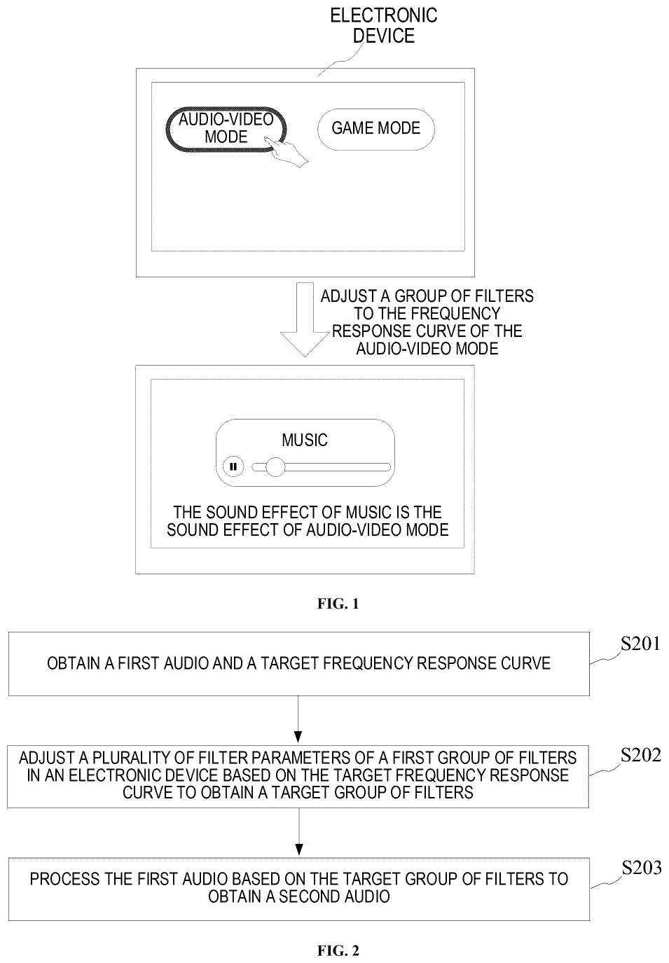

The application scenario of an embodiment of the disclosure will be described below with reference to FIG. 1.

FIG. 1 is a schematic diagram of an application scenario according to an embodiment of the disclosure. Referring to FIG. 1, an electronic device is provided. The display page of the electronic device is an audio mode selection page, and the audio mode selection page comprises an audio-video mode and a game mode. When the user clicks the audio-video mode, the electronic device may adjust the parameters of the group of internal filters to the frequency response curve corresponding to the audio-video mode. When the electronic device plays music, the sound effect of the music played by the electronic device is the sound effect of the audio-video mode. In this way, the electronic device can quickly adjust the filter parameters of the group of filters without manual adjustment for the parameters of the filters, which reduce the parameter adjustment complexity of the filter, and further improve the efficiency of audio processing.

The following provides a detailed explanation of the disclosed technical solution and how it solves the aforementioned technical problems through specific implementations. The following several specific embodiments may be combined with each other, and the same or similar concepts or processes may not be repeated in some embodiments. Embodiments of the disclosure will be described below with reference to the accompanying drawings.

FIG. 2 is a schematic flowchart of a method for processing an audio according to an embodiment of the disclosure. Referring to FIG. 2, the method may comprise:

S201: obtaining a first audio and a target frequency response curve.

The executing body of the embodiment of the disclosure may be an electronic device or an apparatus for processing an audio disposed in the electronic device. The apparatus for processing an audio may be implemented by software, or may be implemented by combining software and hardware, which is not limited in the embodiments of the disclosure.

Optionally, the first audio may be an audio to be played. For example, the first audio may be music to be played by the electronic device, background sound of the video, and the like. Optionally, the frequency response curve indicates a frequency response characteristic of the audio. For example, if the frequency response curve of the audio A is the frequency response curve A and the frequency response curve of the audio B is the frequency response curve B, the audio A is the audio after the frequency response characteristic processing corresponding to the frequency response curve A, and the audio B is the audio after the frequency response characteristic processing corresponding to the frequency response curve B.

It should be noted that each group of filters has a corresponding frequency response characteristic, and each audio has a corresponding frequency response characteristic. After the audio is processed by the group of filters, the frequency response of the processed audio is the superposition of the frequency response of the group of filters and the frequency response of the audio.

Optionally, the frequency response curve may indicate a frequency response characteristic. For example, a horizontal axis of the frequency response curve may be a frequency, and a vertical axis of the frequency response curve may be a strength. Optionally, the target frequency response curve may be a to-be-adjusted frequency response curve of the group of filter group. For example, each group of filters has a corresponding frequency response characteristic, and the target frequency response curve may be a target of the group of filters. After the parameters in the group of filters are adjusted, the frequency response curve corresponding to the frequency response characteristic of the group of filters is the target frequency response curve.

Optionally, the frequency response curve of the first audio is different from the target frequency response curve. For example, if the frequency response curve of the first audio is the frequency response curve A, it indicates that the frequency response characteristic corresponding to the current sound effect of the first audio is the frequency response characteristic of the frequency response curve A, the frequency response curve is different from the target frequency response curve, that is, the sound effect of the frequency response characteristic corresponding to the target frequency response curve is different from the sound effect of the current first audio. Therefore, after the first audio is processed through the target frequency response curve, the sound effect of the obtained audio is the same as the sound effect corresponding to the frequency response characteristic of the target frequency response curve.

Optionally, the electronic device may obtain the first audio and the target frequency response curve based on a feasible implementation: obtaining the first audio and an audio type of the first audio in response to a touch operation for the first audio in a first page; determining the target frequency response curve based on the audio type. Optionally, the first page may be an audio play page. For example, the first page may comprise a plurality of audio to be played. When the user clicks any of the audio to be played, the electronic device determines the audio to be played as the first audio. For example, the audio type may comprise a popular type, a rock type, a game type, and the like.

Optionally, the electronic device may determine the target frequency response curve based on the audio type, specifically by: determining, based on the audio type, a frequency response curve corresponding to the audio type, and determining the target frequency response curve based on the frequency response curve corresponding to the audio type and the frequency response curve of the first audio.

Optionally, the electronic device may obtain a first predetermined relationship, and determine a frequency response curve corresponding to the audio type based on the audio type and the first predetermined relationship. The first predetermined relationship may comprise at least one audio type and a frequency response curve corresponding to each audio type. For example, the first predetermined relationship may be as shown in Table 1:

TABLE 1

| Audio Types | Frequency response curve |
|---|---|
| Type 1 | Curve 1 |
| Type 2 | Curve 2 |
| Type 3 | Curve 3 |
| . . . | . . . |

It should be noted that Table 1 merely illustrates the first predetermined relationship, which is only an example of, but not a limitation on the first predetermined relationship.

For example, if the electronic device determines that the audio type of the first audio is type 1, the electronic device determines that the frequency response curve corresponding to the audio type is curve 1; if the electronic device determines that the audio type of the first audio is type 2, the electronic device determines that the frequency response curve corresponding to the audio type is curve 2; if the electronic device determines that the audio type of the first audio is type 3, the electronic device determines that the frequency response curve corresponding to the audio type is curve 3.

Optionally, the electronic device may determine the target frequency response curve based on the frequency response curve corresponding to the audio type and the frequency response curve of the first audio, specifically by: determining a difference between the frequency response curve corresponding to the audio type and the frequency response curve of the first audio, and determining the target frequency response curve based on the difference. For example, if the frequency response curve corresponding to the audio type is curve A and the frequency response curve of the first audio is curve B, the target frequency response curve is curve A-curve B, that is, the difference between curve A and curve B is compensated through the group of filters. In this way, after processing the first audio through the group of filters, the frequency response curve of the audio heard by the user is curve A.

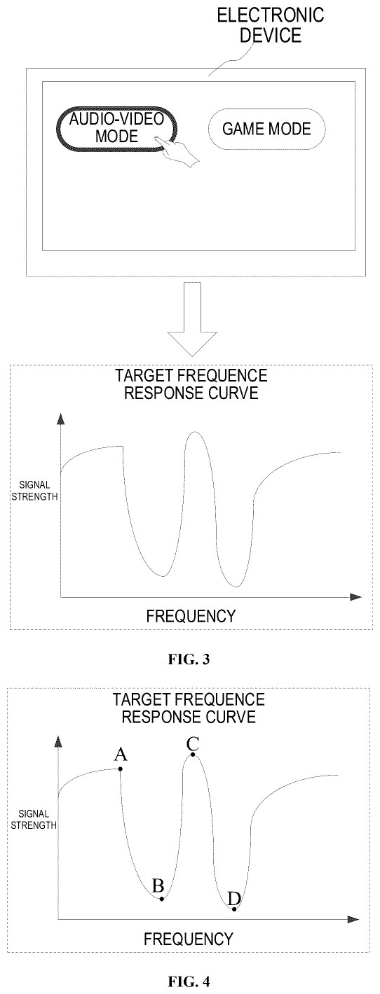

The process of obtaining the target frequency response curve is described below with reference to FIG. 3.

FIG. 3 is a schematic diagram of obtaining a target frequency response curve according to an embodiment of the disclosure. Referring to FIG. 3, an electronic device is comprised. The display page of the electronic device is an audio mode selection page, and the audio mode selection page comprises a audio-video mode and a game mode. When the user clicks the audio-video mode, the electronic device may obtain the frequency response curve corresponding to the audio-video mode, and determine the target frequency response curve according to the frequency response curve corresponding to the audio-video mode and the frequency response curve of the audio received by the electronic device. The vertical axis of the target frequency response curve is signal strength, and the horizontal axis of the target frequency response curve is frequency.

S202: adjusting a plurality of filter parameters of a first group of filters in an electronic device based on the target frequency response curve to obtain a target group of filters.

Optionally, the first group of filters may comprise a plurality of filters, and each filter has a corresponding filter parameter. For example, the first group of filters may comprise a filter A, a filter B, and a filter C. Each filter has a corresponding filter parameter, and the filter parameter may comprise an independent variable of the filter. For example, the filter parameters may comprise a width Q value and height Gain value of a peak or through in a frequency response curve of the filter, and the like.

Optionally, a similarity between the frequency response curve associated with the target group of filters and the target frequency response curve is greater than a predetermined threshold. For example, the frequency response curve of the first group of filters may be determined by the plurality of filter parameters of the first group of filters. After the electronic device adjusts the filter parameter of the first group of filters, the similarity between the frequency response curve and the target frequency response curve is high, thus to obtain the target group of filters.

Optionally, the electronic device may obtain the target group of filters based on the following feasible implementation: obtaining peak information of the target frequency response curve; adjusting the plurality of filter parameters of the first group of filters based on the peak information and the target frequency response curve to obtain the target group of filters.

Optionally, the peak information may be information of a wave peak or a wave trough in the target frequency response curve. Optionally, the peak value information comprises at least one of: a height, a width and a spectral position of a wave peak or a wave trough. Optionally, the height of the peak and trough may be a height (Gain) of a wave peak or a wave trough in the target frequency response curve. For example, the target frequency response curve comprises a wave peak and a wave trough. If the signal strength (height) of the wave peak is 30 dB and the signal strength of the wave trough is −20 dB, the height of the wave or trough may comprise 30 dB and −20 dB.

Optionally, the width of the peak or trough may be the width of the wave peak or the wave trough. For example, the width of the peak or through may be the Q value in the filter, which is the reciprocal of the quotient of the peak width divided by the peak frequency position when the signal strength of the peak drops by half.

Optionally, a spectral position (f) of the peak or trough may be a spectral position of a wave peak or a wave trough. For example, the target frequency response curve comprises a wave peak and a wave trough, if the frequency of the wave peak is 1000 Hz, the spectral position where the wave peak is located is a position of 1000 Hz, and if the frequency of the wave trough is 10000 Hz, the spectral position where the wave trough is located is a position of 10000 Hz.

Optionally, the electronic device may process the target frequency response curve with a predetermined algorithm, to obtain the peak information corresponding to the target frequency response curve. For example, the electronic device may process the target frequency response curve through a peak detection algorithm, so as to obtain peak information such as the number of peaks and troughs in the target frequency response curve, the height of the peak or trough, and the width of the peak or trough, and the electronic device may also obtain the peak information of the target frequency spectrum curve in other ways, which is not limited in the embodiments of the disclosure.

The peak information in the target frequency response curve is described below with reference to FIG. 4.

FIG. 4 is a schematic diagram of peak information according to an embodiment of the disclosure. Referring to FIG. 4, a target frequency response curve is comprised. The vertical axis of the target frequency response curve is signal strength, and the horizontal axis of the target frequency response curve is frequency. The midpoint A and the point C of the target frequency response curve are two wave peaks, the point B and the point D are two wave troughs. Taking point C as an example, the horizontal ordinate of the point C is the spectral position where the wave peak is located, the vertical ordinate of the point C is the height of the wave peak, and the width of the wave peak corresponding to the point C may be the reciprocal of the quotient of the peak width divided by the peak frequency position when the signal strength of the peak drops by half.

S203: processing the first audio based on the target group of filters to obtain the second audio.

Optionally, after the electronic device obtains the target group of filters, the first audio may be processed through the target group of filters to obtain the second audio. For example, the electronic device may input the first audio to the target group of filters, and the target group of filters may output the second audio.

The embodiment of the disclosure provides a method for processing an audio. The electronic device obtains a first audio and a target frequency response curve, and obtains peak information of the target frequency response curve. The electronic device adjusts the plurality of filter parameters of the first group of filters based on the peak information and the target frequency response curve to obtain the target group of filters; and processes the first audio based on the target group of filters to obtain the second audio. In the foregoing method, since the similarity between the frequency response curve corresponding to the target group of filters and the target frequency response curve is relatively high, the sound effect of the second audio obtained by the target group of filters is better, the audio processing effect is improved. In addition, since the electronic device may automatically adjust the plurality of filter parameters in the first group of filters based on the target frequency response curve, the electronic device may quickly obtain the target group of filters without manually adjusting the parameters of the filter, which reduce the parameter adjustment complexity of the filter, and further improve the efficiency of audio processing.

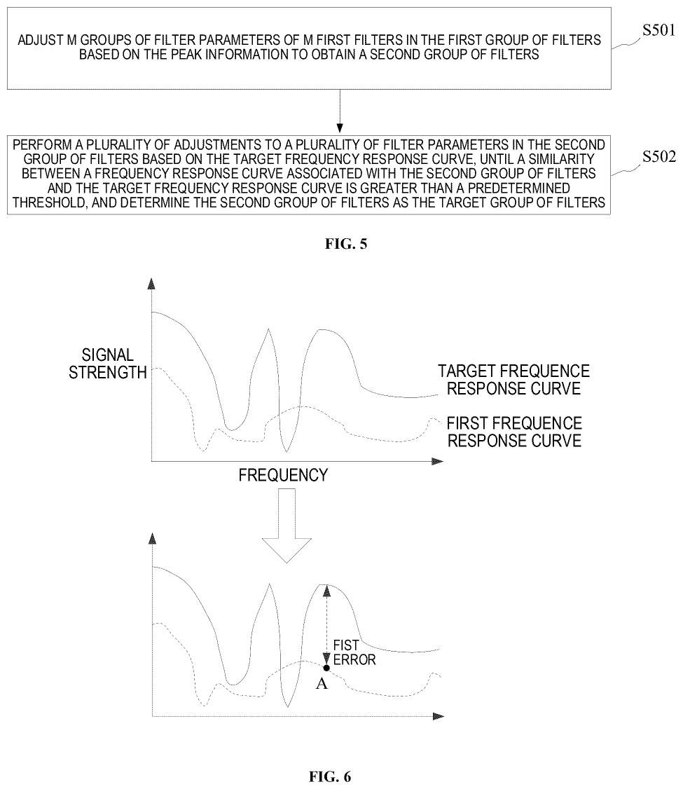

Based on the embodiment shown in FIG. 2, with reference to FIG. 5, for the above method for processing an audio, the following are described in detail: adjusting a plurality of filter parameters of a first group of filters based on the peak information and the target frequency response curve to obtain a target group of filters.

FIG. 5 is a schematic diagram of a method for determining a target group of filters according to an embodiment of the disclosure. Referring to FIG. 5, the method comprises the following:

S501: adjusting M groups of filter parameters of M first filters in the first group of filters based on the peak information to obtain a second group of filters.

Optionally, the first filter may be any filter in the first group of filters. It should be noted that the filters in the first group of filters may be pre-generated filters or real-time generated filters, which is not limited in the disclosed embodiment.

Optionally, M is a number of peaks in the target frequency response curve. For example, if the target frequency response curve comprises 5 peaks, the number of the first filters in the first group of filters is 5; if the target frequency response curve comprises 5 troughs, the number of the first filters in the first group of filters is 5; and if the target frequency response curve comprises 5 peaks and 5 troughs, the number of the first filters in the first group of filters is 10.

Optionally, after the electronic device adjusts the filter parameters of the M first filters in the first group of filters, the second group of filters may be obtained. It should be noted that the filter parameters of each filter in the first group of filters may be random values or predetermined values, which is not limited in the disclosed embodiment.

Optionally, for any of the first filter, the electronic device may adjust the filter parameters of the first filter in the first group of filters based on a feasible implementation: determining target peak information corresponding to the first filter. For example, if the target frequency response curve comprises 5 peaks and 5 troughs, the electronic device may determine peak information of 10 peaks and throughs based on the target frequency response curve, and determine 10 first filters in the first group of filters, where each peak information has a corresponding first filter. For example, if the electronic device obtains the peak information A, the peak information B, and the peak information C based on the target frequency response curve, the electronic device determines the first filter A, the first filter B, and the first filter C in the first group of filters, where the peak information corresponding to the first filter A may be the peak information A, the peak information corresponding to the first filter B may be the peak information B, and the peak information corresponding to the first filter C may be the peak information C.

Optionally, the filter parameter corresponding to the target peak information is determined as the filter parameter of the first filter. For example, in an actual application process, the adjustable independent variable of the filter parameter may be a height, a width, and a spectral position of the peak or trough. Therefore, the filter parameter of the first filter may be set by means of the peak information. For example, if the peak information corresponding to the first filter is: the height of the peak and trough is 30 dB, the width of the peak and trough is 1/100, and the spectral position of the peak and trough is 1000 Hz, the electronic device may set the three parameters of the first filter to be 30 dB, 1/100 and 1000 Hz. In such a way, the similarity between the partial curve presented by the first filter and the peak and trough curve in the target frequency response curve is higher. In this way, the electronic device may fix the filter parameter of the first filter through the peak information, thereby reducing the adjustment complexity of the filter parameter, improving the adjustment efficiency of the filter parameter, and further improving the audio processing efficiency.

S502: performing a plurality of adjustments to a plurality of filter parameters in the second group of filters based on the target frequency response curve, until a similarity between a frequency response curve associated with the second group of filters and the target frequency response curve is greater than a predetermined threshold, and determining the second group of filters as the target group of filters.

Optionally, the electronic device may perform a plurality of adjustments to the plurality of filter parameters in the second group of filters based on the following feasible implementation: for the i-th adjustment, obtaining a first frequency response curve associated with the second group of filters; adjusting a plurality of filter parameters of the second group of filters based on the first frequency response curve and the target frequency response curve. Optionally, i may equal to 1, . . . , N, and N is the number of adjustments corresponding to a similarity between the first frequency response curve and the target frequency response curve that is greater than the predetermined threshold, and N is an integer greater than 0.

Optionally, the first frequency response curve may be a frequency response curve associated with the second group of filters. It should be noted that after each adjustment of the parameters in the second group of filters, the first frequency response curve corresponding to the second group of filters will also change. When the similarity between the first frequency response curve and the target frequency response curve is high, the adjustment to the second group of filters will be stopped, and the second group of filters will be determined as the target group of filters. For example, if the similarity between the first frequency response curve associated with the second group of filters and the target frequency response curve is greater than the predetermined threshold after the filter parameters in the second group of filters are adjusted for 10 times, the electronic device stops adjusting the filter parameters of the second group of filters, and the electronic device determines that N is 10.

It should be noted that, the electronic device may determine the similarity between the first frequency response curve and the target frequency response curve through the error between the first frequency response curve and the target frequency response curve. The electronic device may further process the first frequency response curve and the target frequency response curve through the image recognition model to obtain the similarity between the first frequency response curve and the target frequency response curve, which is not limited in the embodiments of the disclosure.

Optionally, the electronic device may adjust the plurality of filter parameters of the second group of filters based on a feasible implementation: obtaining a plurality of first errors of a plurality of target points in the first frequency response curve with respect to the target frequency response curve; adjusting the plurality of filter parameters of the second group of filters based on the plurality of first errors.

Optionally, the target point may be any point in the first frequency response curve. For example, the electronic device may determine any point in the first frequency response curve as the target point. The electronic device may further determine all points in the first frequency response curve as the target point, which is not limited in the embodiments of the disclosure. Optionally, the first error may be a distance from the target point of the first frequency response curve to the target frequency response curve. For example, if the distance between the target point A in the first frequency response curve and the target frequency response curve is 10 dB, the first error corresponding to the target point is 10 dB, and if the distance between the target point B in the first frequency response curve and the target frequency response curve is 20 dB, the first error corresponding to the target point is 20 dB.

It should be noted that, when the filter parameter is actually adjusted, if the filter parameter of one filter is adjusted, the first error of the plurality of target points is affected. Therefore, when the filter parameter is adjusted with the error, the average error of the plurality of target points, the expected value of the error, or the average number of the nth square of the error may be determined as the first error. For example, for the errors of multiple points, the errors may be averaged, or the N times of the errors or the derivative function thereof may be averaged. At the same time, in the process of calculating errors, weighting may be carried out based on the sensitivity of the human ear to auditory frequency response. The recommended weighting mode is to weight based on a linear correlation with the logarithm of the frequency, which is not limited in this disclosed embodiment.

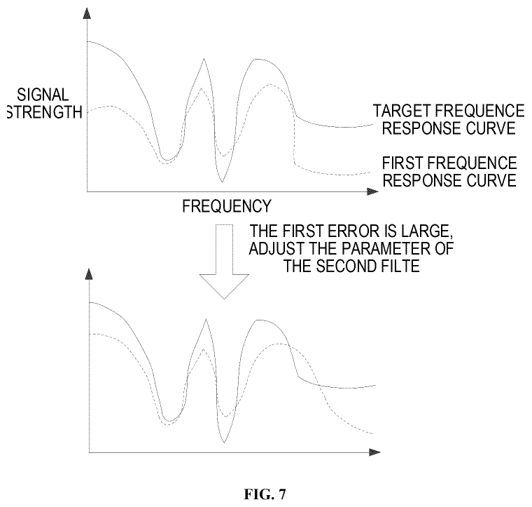

The first error is described below with reference to FIG. 6.

FIG. 6 is a schematic diagram of a first error provided by an embodiment of the disclosure. Referring to FIG. 6, a coordinate axis is comprised. The horizontal axis of the coordinate axis is frequency, and the vertical axis of the coordinate axis is signal strength. The coordinate axis comprises a target frequency response curve and a first frequency response curve. Taking the point A in the first frequency response curve as an example, the distance between the point A and the target frequency response curve may be the first error corresponding to the point A. In an actual application process, a parameter of one filter may affect an error between a plurality of points. An average value of distances between the plurality of points and the target frequency response curve may be determined as a first error corresponding to a filter parameter of the filter.

Optionally, the adjusting the plurality of filter parameters of the second group of filters based on the plurality of first errors specifically comprises: determining, based on the plurality of first errors, a plurality of adjustment steps associated with the plurality of filter parameters of the second group of filters; adjusting the plurality of filter parameters of the second group of filters based on the plurality of adjustment steps.

Optionally, the adjustment step is used to indicate a degree of adjustment of the filter parameter. Optionally, the first error is positively correlated with the adjustment step. For example, if the error between the first frequency response curve and the target frequency response curve is larger, the adjustment step determined by the electronic device will be larger; and if the error between the first frequency response curve and the target frequency response curve is smaller, the adjustment step determined by the electronic device will be smaller. Optionally, when determining the adjustment step, the momentum control parameter may be combined, so that the current adjustment step may not only be related to the current first error but also be related to the previous first error, which may improve the adjustment effect of the filter parameter.

Optionally, the electronic device may determine a second predetermined relationship between the error and the adjustment step, and further determine the adjustment step by using the second predetermined relationship and the first error. For example, the second predetermined relationship may be as shown in Table 2:

TABLE 2

| Error | Adjustment Step |
|---|---|
| Error 1 | Step 1 |
| Error 2 | Step 2 |
| Error 3 | Step 3 |
| . . . | . . . |

It should be noted that Table 2 illustrates the second predetermined relationship in an example, and is not a limitation on the second predetermined relationship.

For example, if the electronic device determines that the first error is the error 1, the electronic device determines that the adjustment step is the step 1; if the electronic device determines that the first error is the error 2, the electronic device determines that the adjustment step is the step 2; and if the electronic device determines that the first error is the error 3, the electronic device determines that the adjustment step is the step 3.

Optionally, the electronic device adjusts the plurality of filter parameters of the second group of filters based on the plurality of adjustment steps, and there are the following two cases:

Case 1: i is less than or equal to K.

For i being less than or equal to K, filter parameters of the M first filters are fixed, and filter parameters of the second filter are adjusted based on the plurality of adjustment steps. Optionally, K is an integer greater than 1 and less than N. After the Kth adjustment is performed on the plurality of filter parameters in the second group of filters, a change rate of the plurality of first errors is less than or equal to a second threshold. For example, after the electronic device adjusts the filter parameters in the second group of filters for 5 times, the similarity between the first frequency response curve and the target frequency response curve is the similarity A. After the electronic device adjusts filter parameters in the second group of filters for 6 times, the similarity between the first frequency response curve and the target frequency response curve is the similarity B. If the error between the similarity A and the similarity B is small, the electronic device determines that the change rate of the first error is less than or equal to the second threshold.

Optionally, the second filter is a filter in the second group of filters different from a first filter. For example, the second group of filters comprises 10 filters, and if the 3 filters are the first filters, the remaining 7 filters are the second filters. Optionally, the electronic device may adjust the filter parameter of the second filter based on the plurality of adjustment step and the gradient descent algorithm.

In this case, the electronic device may fix the filter parameter of the first filter, and adjust the filter parameter of the second filter in combination with the adjustment step and the gradient descent algorithm, until the error variation between the first frequency response curve and the target frequency response curve is relatively small. In this way, since the first filter parameter is fixed, the electronic device may adjust the first frequency response curve to a curve similar to the target frequency response curve faster, thereby improving the adjustment efficiency of the filter parameter.

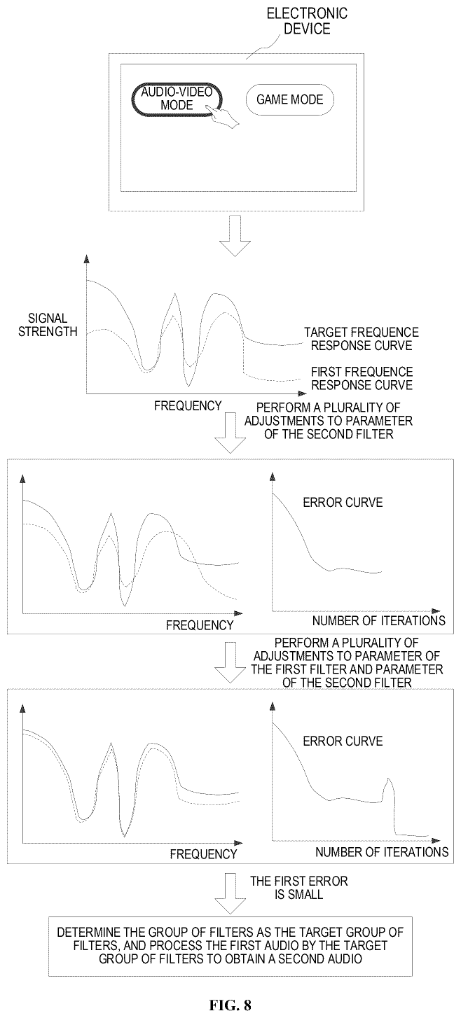

The process of adjusting the filter parameters of the second filter in this case will be described below with reference to FIG. 7.

FIG. 7 is a schematic diagram of adjusting filter parameters according to an embodiment of the disclosure. Please refer to FIG. 7, the coordinate axis. The horizontal axis of the coordinate axis is frequency, and the vertical axis of the coordinate axis is signal strength. The coordinate axis comprises a target frequency response curve and a first frequency response curve. Because the target frequency response curve comprises 2 peaks and 2 troughs, the second group of filters comprises 4 first filters. The filter parameters of the 4 first filters are fixed by the electronic device and are not adjusted, and the remaining second filter parameters are adjusted. Therefore, the first frequency response curves except the wave peaks and wave troughs are close to the target frequency response curve.

Case 2: i is greater than K.

For i being greater than K, the filter parameters of the first filter and the filter parameters of the second filter are adjusted based on the plurality of adjustment steps. Optionally, K is an integer greater than 1 and less than N, and after the Kth adjustment is performed on the plurality of filter parameters in the second group of filters, a change rate of the plurality of first errors is less than or equal to a second threshold.

Optionally, for i being greater than K, the electronic device may release the degree of freedom of the first filter (for example, release a part of filter parameters or all filter parameters), so that the electronic device may adjust the first filter parameter and the second filter parameter. For example, for i being greater than K, it indicates that an error between the first frequency response curve and the target frequency response curve cannot be effectively reduced after the electronic device adjusts the second filter parameter. Therefore, the electronic device may release the degree of freedom of the first filter, and further reduce an error between the first frequency response curve and the target frequency response curve by adjusting the first filter and the second filter.

Optionally, at this time, the number of filters may be increased again. Several random parameter filters are successively added to the second group of filters for error optimization, until the adding number of filters leads to no significant decrease of the error curve, and the optimization is ended.

It should be noted that, when the filter parameters of the first filter and the filter parameters of the second filter are adjusted, the electronic device may release all the filter parameters of the first filter at a time, and then adjust the first filter and the second filter. The electronic device may also release part of the filter parameters of the first filter, and when the change rate of the first error is less than or equal to the second threshold, the unreleased filter parameters in the first filter are released again, and then the first filter and the second filter are adjusted. For example, the electronic device may adjust the high parameter of the peak and trough in the first filter. When the first error change rate is less than or equal to the second threshold, the electronic device may adjust the height of the peak and trough and the width of the peak and trough in the first filter. When the first error change rate is less than or equal to the second threshold again, the electronic device may adjust the height, the width, and the spectral position of the peak and trough in the first filter, which may improve the adjustment efficiency of the filter parameter and improve the stability of the filter parameter adjustment.

Optionally, the electronic device may reduce an error function (for example, a gradient descent algorithm, a gradient descent algorithm with a variable step, or a gradient descent algorithm without a variable step) by using an optimization algorithm, which is not limited in the embodiments of the disclosure, and adjusts a plurality of filter parameters in the second group of filters.

The embodiment of the disclosure provides a method for determining a target group of filters. Based on peak information, the M groups of filter parameters of the M first filters in the first group of filters are adjusted to obtain the second group of filters. Based on the target frequency response curve, the filter parameters in the second group of filters are adjusted for multiple times, until the similarity between the frequency response curve associated with the second group of filters and the target frequency response curve is greater than the preset threshold. Then, the second group of filters is determined as the target group of filters. In this way, since electronic devices can automatically adjust multiple filter parameters in the first group of filters based on the target frequency response curve, there is no need to manually adjust the filter parameters. The electronic devices can quickly obtain the target group of filters, reduce the complexity of filter parameter adjustment, and improve the efficiency of audio processing. Moreover, by adjusting the filter parameters through error convergence and error supervision methods, the efficiency and stability of filter parameter adjustment can be improved.

Based on any one of the foregoing embodiments, a process of the foregoing method for processing an audio is described below with reference to FIG. 8.

FIG. 8 is a schematic diagram of a process of a method for processing an audio according to an embodiment of the disclosure. Referring to FIG. 8, an electronic device is comprised. The display page of the electronic device is an audio mode selection page, and the audio mode selection page comprises a audio-video mode and a game mode. When the user clicks the audio-video mode, the electronic device may obtain a target frequency response curve corresponding to the audio-video mode.

Referring to FIG. 8, a coordinate axis is comprised. The horizontal axis of the coordinate axis is frequency, and the vertical axis of the coordinate axis is signal strength. The coordinate axis comprises a target frequency response curve and a first frequency response curve corresponding to the audio-video mode. The first frequency response curve is a frequency response curve corresponding to a group of filters after the first filter parameter thereof is fixed by the electronic device. The electronic device adjusts the parameters of the second filter in the group of filters for multiple times by using the gradient descent algorithm and the first error, that is, the wave peak curve and the wave trough curve in the first frequency response curve are unchanged, and the curve of other parts is adjusted towards the position close to the target frequency response curve.

Referring to FIG. 8, when the electronic device adjusts the second filter parameter for a plurality of times, the electronic device may obtain an error curve in the adjustment process, where a horizontal axis of the error curve is a number of optimization iterations. When the error curve approaches a smooth state, it indicates that the effect of the smaller error is poor when the electronic device adjusts the second filter parameter, therefore, the electronic device may release the parameter of the first filter. When the electronic device adjusts the parameter of the first filter for the first time, the error in the error curve rises.

Referring to FIG. 8, after the electronic device adjusts the first filter parameter and the second filter parameter for multiple times, the error in the error curve is reduced. When the similarity between the first frequency response curve and the target frequency response curve is relatively high, the first error is relatively small, the electronic device may determine the group of filters as the target group of filters, and process the first audio through the target group of filters to obtain the second audio. In this way, the electronic device can adjust the frequency response curve corresponding to the group of filters according to any target frequency response curve, so that the flexibility of audio processing is improved, the electronic device does not need to manually adjust the parameters of the filter. The electronic device can quickly obtain the target group of filters, the parameter adjustment complexity of the filter is reduced, the audio processing efficiency is improved, the filter parameters are adjusted through the error convergence and error supervision method, and the adjustment efficiency and the adjustment stability of the filter parameters can be improved.

FIG. 9 is a schematic structural diagram of an apparatus for processing an audio according to an embodiment of the disclosure. Referring to FIG. 9, the apparatus 90 for processing an audio comprises an obtaining module 91, an adjusting module 92, and a processing module 93, wherein:
the obtaining module 91 is configured to obtain a first audio and a target frequency response curve, the first audio having a frequency response curve different from the target frequency response curve;
the adjusting module 92 is configured to adjust a plurality of filter parameters of a first group of filters in an electronic device based on the target frequency response curve to obtain a target group of filters, a similarity between a frequency response curve associated with the target group of filters and the target frequency response curve being greater than a predetermined threshold;
the processing module 93 is configured to process the first audio based on the target group of filters to obtain a second audio.

According to one or more embodiments of this disclosure, the adjusting module 92 is configured to:
obtaining peak information of the target frequency response curve, the peak information being information of a wave peak or a wave trough in the target frequency response curve, and the peak value information comprising at least one of: a height, a width and a spectral position of a wave peak or a wave trough;
adjusting the plurality of filter parameters of the first group of filters based on the peak information and the target frequency response curve to obtain the target group of filters.

According to one or more embodiments of this disclosure, the adjusting module 92 is configured to:
adjusting M groups of filter parameters of M first filters in the first group of filters based on the peak information to obtain a second group of filters, M being a number of peaks in the target frequency response curve;
performing a plurality of adjustments to a plurality of filter parameters in the second group of filters based on the target frequency response curve, until a similarity between a frequency response curve associated with the second group of filters and the target frequency response curve is greater than a predetermined threshold, and determining the second group of filters as the target group of filters.

According to one or more embodiments of this disclosure, the adjusting module 92 is specifically configured to:
for the i-th adjustment;
obtaining a first frequency response curve associated with the second group of filters;
adjusting a plurality of filter parameters of the second group of filters based on the first frequency response curve and the target frequency response curve;
wherein i is equal to 1, . . . , N, and N is the number of adjustments corresponding to a similarity between the first frequency response curve and the target frequency response curve that is greater than the predetermined threshold, and N is an integer greater than 0.

According to one or more embodiments of this disclosure, the adjusting module 92 is specifically configured to:
obtaining a plurality of first errors of a plurality of target points in the first frequency response curve with respect to the target frequency response curve;
adjusting the plurality of filter parameters of the second group of filters based on the plurality of first errors.

According to one or more embodiments of this disclosure, the adjusting module 92 is specifically configured to:
determining, based on the plurality of first errors, a plurality of adjustment steps associated with the plurality of filter parameters of the second group of filters, the first error being positively correlated with the adjustment step;
adjusting the plurality of filter parameters of the second group of filters based on the plurality of adjustment steps.

According to one or more embodiments of this disclosure, the adjusting module 92 is specifically configured to:
for i being less than or equal to K, adjusting filter parameters of a second filter based on the plurality of adjustment steps by fixing filter parameters of the M first filters, the second filter being a filter in the second group of filters different from a first filter; and
for i being greater than K, adjusting a filter parameter of the first filter and a filter parameter of the second filter based on the plurality of adjustment steps;
wherein K is an integer greater than 1 and less than N, and after the Kth adjustment is performed to the plurality of filter parameters in the second group of filters, a change rate of the plurality of first errors is less than or equal to a second threshold.

According to one or more embodiments of this disclosure, the adjusting module 92 is specifically configured to:
determining target peak information corresponding to the first filter;
determining a filter parameter corresponding to the target peak information as a filter parameter of the first filter.

According to one or more embodiments of this disclosure, the adjusting module 92 is specifically configured to:
obtaining the first audio and an audio type of the first audio in response to a touch operation for the first audio in a first page;
determining the target frequency response curve based on the audio type.

The apparatus for processing an audio provided in the embodiments of the disclosure may be configured to perform the technical solutions in the foregoing method embodiments, and implementation principles and technical effects thereof are similar, and details are not repeated in this embodiment.

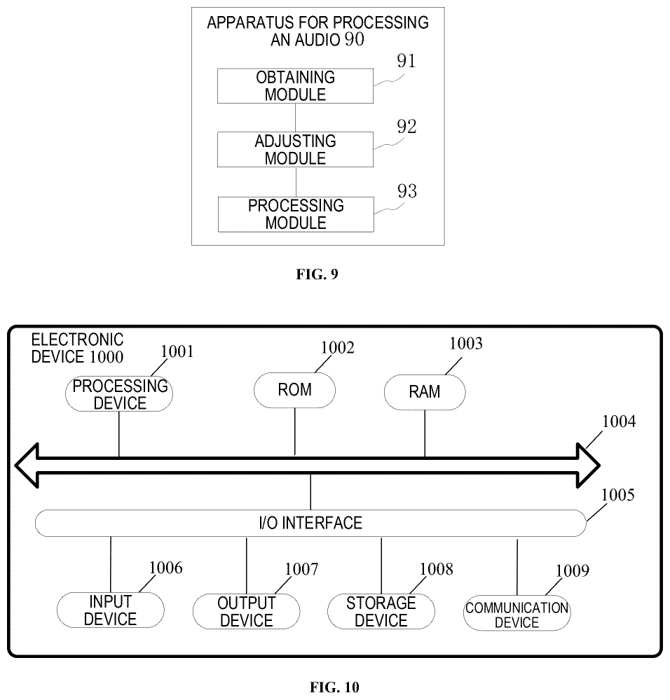

FIG. 10 is a schematic structural diagram of an electronic device according to an embodiment of the disclosure. Referring to FIG. 10, it shows a schematic structural diagram of an electronic device 1000 suitable for implementing embodiments of the disclosure. The electronic device 1000 may be a terminal device or a server. The terminal device may comprise, but is not limited to, a mobile terminal such as a mobile phone, a notebook computer, a digital broadcast receiver, a personal digital assistant (PDA), a portable Android device (PAD), a portable media player (PMP), an on-board terminal (for example, an on-board navigation terminal), and a fixed terminal such as a digital TV, a desktop computer, or the like. The electronic device shown in FIG. 10 is merely an example, and should not impose any limitation on the functions and scope of use of the embodiments of the present disclosure.

As shown in FIG. 10, the electronic device 1000 may comprise a processing device (for example, a central processing unit, a graphics processor, etc.) 1001, which may perform various appropriate actions and processing according to a program stored in a read only memory (ROM) 1002 or a program loaded into a random access memory (RAM) 1003 from a storage device 1008. In the RAM 1003, various programs and data required by the operation of the electronic device 1000 are also stored. The processing device 1001, the ROM 1002, and the RAM 1003 are connected to each other through a bus 1004. Input/output (I/O) interface 1005 is also connected to bus 1004.

Generally, the following devices may be connected to the I/O interface 1005: an input device 1006 comprising, for example, a touch screen, a touch pad, a keyboard, a mouse, a camera, a microphone, an accelerometer, a gyroscope, etc.; an output device 1007 comprising, for example, a liquid crystal display (LCD), a speaker, a vibrator, etc.; a storage device 1008 comprising, for example, a magnetic tape, a hard disk, etc.; and a communication device 1009. The communication device 1009 may allow the electronic device 1000 to communicate wirelessly or wired with other devices to exchange data. While FIG. 10 shows an electronic device 1000 having various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure comprise a computer program product comprising a computer program embodied on a computer readable medium, the computer program comprising program code for performing the method shown in the flowchart. In such embodiments, the computer program may be downloaded and installed from the network through the communication device 1009, or installed from the storage device 1008, or from the ROM 1002. When the computer program is executed by the processing apparatus 1001, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may comprise, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer readable signal medium may comprise a data signal propagated in baseband or as part of a carrier, where the computer readable program code is carried. Such propagated data signals may take a variety of forms comprising, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, comprising, but not limited to: wires, optical cables, RF (radio frequency), and the like, or any suitable combination of the foregoing.

The computer-readable medium described above may be comprised in the electronic device; or may be separately present without being assembled into the electronic device.

The computer-readable medium described above may be comprised in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, comprising object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, comprising a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that comprises one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “a unit for obtaining at least two Internet Protocol addresses”.

The functions described above may be performed, at least in part, by one or more hardware logic components. For example, without limitation, exemplary types of hardware logic components that may be used comprise: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may comprise, but is not limited to, electronic, magnetic, optical, electromagnetic, infrared, or semiconductor systems, devices, or devices, or any suitable combination of the foregoing. More specific examples of machine-readable storage media may comprise electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

It should be noted that the modification of “a” and “a plurality of” mentioned in this disclosure is illustrative and not limiting, and those skilled in the art should understand that “one or more” should be understood unless the context clearly indicates otherwise.

The names of messages or information exchanged between multiple devices in embodiments of the disclosure are for illustrative purposes only and are not intended to limit the scope of such messages or information.

It can be understood that, before the technical solutions disclosed in the embodiments of the disclosure are used, the types of personal information related to the disclosure, the usage scope, the usage scenario and the like should be notified to the user in an appropriate manner according to the relevant laws and regulations and obtain the authorization of the user.

For example, in response to receiving an active request from a user, prompt information is sent to the user to explicitly prompt the user that the requested operation will need to acquire and use the personal information of the user. Therefore, users may be enabled to autonomously choose whether to provide personal information to software or hardware such as electronic devices, applications, servers, or storage media that perform the operations of the disclosed technical solution based on prompt information.

As an optional but non-limiting implementation, in response to receiving an active request of the user, a manner of sending prompt information to the user may be, for example, a pop-up window, and prompt information may be presented in a text in the pop-up window. In addition, the pop-up window may further carry a selection control for the user to select “agree” or “disagree” to provide personal information to the electronic device.

It may be understood that the foregoing notification and obtaining a user authorization process are merely illustrative, and do not constitute a limitation on implementations of the present disclosure, and other manners meeting related laws and regulations may also be applied to implementations of the present disclosure.

It may be understood that the data involved in the technical solution (including but not limited to the data itself, the obtaining or use of the data) should follow the requirements of the corresponding laws and related regulations. The data may comprise information, parameters, messages, and the like, such as flow cut indication information.

The foregoing description is merely illustration of the preferred embodiments of the present disclosure and the technical principles used herein. Those skilled in the art should understand that the disclosure scope involved therein is not limited to the technical solutions formed from a particular combination of the above technical features, but should also cover other technical solutions formed by any combination of the above technical features or their equivalent features without departing from the above disclosure concepts, e.g., technical solutions formed by replacing the above features with technical features having similar functions disclosed (without limitation) in the present disclosure.

In addition, although various operations have been depicted in a particular order, it should not be construed as requiring that the operations be performed in the particular order shown or in sequential order of execution. Multitasking and parallel processing may be advantageous in certain environments. Likewise, although the foregoing discussion includes several specific implementation details, they should not be construed as limiting the scope of the present disclosure. Some features described in the context of separate embodiments may also be realized in combination in a single embodiment. On the contrary, various features described in the context of a single embodiment may also be realized in a plurality of embodiments, either individually or in any suitable sub-combinations.

While the present subject matter has been described using language specific to structural features and/or method logic actions, it should be understood that the subject matter defined in the appended claims is not necessarily limited to the particular features or actions described above. On the contrary, the particular features and actions described above are merely example forms of realizing the claims.

1. A method for processing an audio, comprising:
obtaining a first audio and a target frequency response curve;
adjusting a plurality of filter parameters of a first group of filters in an electronic device based on the target frequency response curve to obtain a target group of filters, a similarity between a frequency response curve associated with the target group of filters and the target frequency response curve being greater than a predetermined threshold; and
processing the first audio based on the target group of filters to obtain a second audio.

2. The method of claim 1, the adjusting a plurality of filter parameters of a first group of filters in an electronic device based on the target frequency response curve to obtain a target group of filters comprises:
obtaining peak information of the target frequency response curve, the peak information being information of a wave peak or a wave trough in the target frequency response curve, and the peak value information comprising at least one of: a height, a width and a spectral position of a wave peak or a wave trough; and
adjusting the plurality of filter parameters of the first group of filters based on the peak information and the target frequency response curve to obtain the target group of filters.

3. The method of claim 2, the adjusting the plurality of filter parameters of the first group of filters based on the peak information and the target frequency response curve to obtain the target group of filters comprises:
adjusting M groups of filter parameters of M first filters in the first group of filters based on the peak information to obtain a second group of filters, M being a number of peaks in the target frequency response curve; and
performing a plurality of adjustments to a plurality of filter parameters in the second group of filters based on the target frequency response curve, until a similarity between a frequency response curve associated with the second group of filters and the target frequency response curve is greater than a predetermined threshold, and determining the second group of filters as the target group of filters.

4. The method of claim 3, the adjusting a plurality of filter parameters in the second group of filters for a plurality of times based on the target frequency response curve comprises:
for the i-th adjustment;
obtaining a first frequency response curve associated with the second group of filters;
adjusting a plurality of filter parameters of the second group of filters based on the first frequency response curve and the target frequency response curve;
wherein i is equal to 1, . . . , N, and N is the number of adjustments corresponding to a similarity between the first frequency response curve and the target frequency response curve that is greater than the predetermined threshold, and Nis an integer greater than 0.

5. The method of claim 4, adjusting the plurality of filter parameters of the second group of filters based on the first frequency response curve and the target frequency response curve comprises:
obtaining a plurality of first errors of a plurality of target points in the first frequency response curve with respect to the target frequency response curve;
adjusting the plurality of filter parameters of the second group of filters based on the plurality of first errors.

6. The method of claim 5, the adjusting the plurality of filter parameters of the second group of filters based on the plurality of first errors comprises:
determining, based on the plurality of first errors, a plurality of adjustment steps associated with the plurality of filter parameters of the second group of filters, the first error being positively correlated with the adjustment step; and
adjusting the plurality of filter parameters of the second group of filters based on the plurality of adjustment steps.

7. The method of claim 6, the adjusting the plurality of filter parameters of the second group of filters based on the plurality of adjustment steps comprises:
for i being less than or equal to K, adjusting filter parameters of a second filter based on the plurality of adjustment steps by fixing filter parameters of the M first filters, the second filter being a filter in the second group of filters different from a first filter; and
for i being greater than K, adjusting a filter parameter of the first filter and a filter parameter of the second filter based on the plurality of adjustment steps;
wherein K is an integer greater than 1 and less than N, and after the Kth adjustment is performed to the plurality of filter parameters in the second group of filters, a change rate of the plurality of first errors is less than or equal to a second threshold.

8. The method of claim 3, for any of the first filters, the adjusting a filter parameter of a first filter in the first group of filters based on the peak information comprises:
determining target peak information corresponding to the first filter;
determining a filter parameter corresponding to the target peak information as a filter parameter of the first filter.

9. The method of claim 1, obtaining a first audio and a target frequency response curve comprises:
obtaining the first audio and an audio type of the first audio in response to a touch operation for the first audio in a first page; and
determining the target frequency response curve based on the audio type.

10. (canceled)

11. An electronic device, comprising: a processor and a memory;
the memory storing computer executable instructions; and
the processor executing the computer executable instruction stored in the memory, to cause the processor to execute acts comprising:
obtaining a first audio and a target frequency response curve;
adjusting a plurality of filter parameters of a first group of filters in an electronic device based on the target frequency response curve to obtain a target group of filters, a similarity between a frequency response curve associated with the target group of filters and the target frequency response curve being greater than a predetermined threshold; and
processing the first audio based on the target group of filters to obtain a second audio.

12-13. (canceled)

14. The electronic device of claim 11, the adjusting a plurality of filter parameters of a first group of filters in an electronic device based on the target frequency response curve to obtain a target group of filters comprises:
obtaining peak information of the target frequency response curve, the peak information being information of a wave peak or a wave trough in the target frequency response curve, and the peak value information comprising at least one of: a height, a width and a spectral position of a wave peak or a wave trough; and
adjusting the plurality of filter parameters of the first group of filters based on the peak information and the target frequency response curve to obtain the target group of filters.

15. The electronic device of claim 14, the adjusting the plurality of filter parameters of the first group of filters based on the peak information and the target frequency response curve to obtain the target group of filters comprises:
adjusting M groups of filter parameters of M first filters in the first group of filters based on the peak information to obtain a second group of filters, M being a number of peaks in the target frequency response curve; and
performing a plurality of adjustments to a plurality of filter parameters in the second group of filters based on the target frequency response curve, until a similarity between a frequency response curve associated with the second group of filters and the target frequency response curve is greater than a predetermined threshold, and determining the second group of filters as the target group of filters.

16. The electronic device of claim 15, the adjusting a plurality of filter parameters in the second group of filters for a plurality of times based on the target frequency response curve comprises:
for the i-th adjustment;
obtaining a first frequency response curve associated with the second group of filters;
adjusting a plurality of filter parameters of the second group of filters based on the first frequency response curve and the target frequency response curve;
wherein i is equal to 1, . . . , N, and N is the number of adjustments corresponding to a similarity between the first frequency response curve and the target frequency response curve that is greater than the predetermined threshold, and N is an integer greater than 0.

17. The electronic device of claim 16, adjusting the plurality of filter parameters of the second group of filters based on the first frequency response curve and the target frequency response curve comprises:
obtaining a plurality of first errors of a plurality of target points in the first frequency response curve with respect to the target frequency response curve;
adjusting the plurality of filter parameters of the second group of filters based on the plurality of first errors.

18. The electronic device of claim 17, the adjusting the plurality of filter parameters of the second group of filters based on the plurality of first errors comprises:
determining, based on the plurality of first errors, a plurality of adjustment steps associated with the plurality of filter parameters of the second group of filters, the first error being positively correlated with the adjustment step; and
adjusting the plurality of filter parameters of the second group of filters based on the plurality of adjustment steps.

19. The electronic device of claim 18, the adjusting the plurality of filter parameters of the second group of filters based on the plurality of adjustment steps comprises:
for i being less than or equal to K, adjusting filter parameters of a second filter based on the plurality of adjustment steps by fixing filter parameters of the M first filters, the second filter being a filter in the second group of filters different from a first filter; and
for i being greater than K, adjusting a filter parameter of the first filter and a filter parameter of the second filter based on the plurality of adjustment steps;
wherein K is an integer greater than 1 and less than N, and after the Kth adjustment is performed to the plurality of filter parameters in the second group of filters, a change rate of the plurality of first errors is less than or equal to a second threshold.

20. The electronic device of claim 15, for any of the first filters, the adjusting a filter parameter of a first filter in the first group of filters based on the peak information comprises:
determining target peak information corresponding to the first filter;
determining a filter parameter corresponding to the target peak information as a filter parameter of the first filter.

21. The electronic device of claim 11, obtaining a first audio and a target frequency response curve comprises:
obtaining the first audio and an audio type of the first audio in response to a touch operation for the first audio in a first page; and
determining the target frequency response curve based on the audio type

22. A non-transitory computer-readable storage medium, wherein the computer-readable storage medium stores computer-executable instructions which, when executed by a processor, implement a method for processing an audio according to claim 1.

23. The non-transitory computer-readable storage medium of claim 22, the adjusting a plurality of filter parameters of a first group of filters in an electronic device based on the target frequency response curve to obtain a target group of filters comprises:
obtaining peak information of the target frequency response curve, the peak information being information of a wave peak or a wave trough in the target frequency response curve, and the peak value information comprising at least one of: a height, a width and a spectral position of a wave peak or a wave trough; and
adjusting the plurality of filter parameters of the first group of filters based on the peak information and the target frequency response curve to obtain the target group of filters.
